(19) United States
(12) Patent Application Publication
(10) Pub. No.: US 2011/0059250 A1
(43) Pub. Date: Mar. 10, 2011

(54) COATING METHOD AND COATING APPARATUS

(75) Inventors: Hidenori MIYAMOTO, Kawasaki-shi (JP); Kenji MARUYAMA, Kawasaki-shi (JP); Tadahiko HIRAKAWA, Kawasaki-shi (JP); Koichi MISUMI, Kawasaki-shi (JP)

(73) Assignee: TOKYO OHKA KOGYO CO., LTD., Kawasaki-shi (JP)

(21) Appl. No.: 12/874,101

(22) Filed: Sep. 1, 2010

(30) Foreign Application Priority Data
Sep. 8, 2009 (JP) 2009-207139
Aug. 17, 2010 (JP) 2010-182316

(51) Int. Cl. B05D 3/00; B05D 3/02; B05D 1/36; B05D 3/04; B05C 13/02

(52) U.S. Cl. 427/374.1; 427/372.2; 427/404; 118/64

(57) ABSTRACT

A coating method including coating a liquid material including an oxidizable metal on a substrate a plurality of times to laminate a plurality of liquid material layers on the substrate; and adjusting at least one of oxygen concentration and humidity inside a chamber having a coating space in which the coating part applies the liquid material on the substrate and a transport space into which the liquid material is transported.

### BACKGROUND OF THE INVENTION

1. Field of the Invention

The present invention relates to a coating method and a coating apparatus.

2. Description of the Related Art

A CIGS solar cell or a CZTS solar cell formed by semiconductor materials including a metal such as Cu, Ge, Sn, Pb, Sb, Bi, Ga, In, Ti, Zn, and a combination thereof, and a chalcogen element such as S, Se, Te, and a combination thereof has been attracting attention as a solar cell having high conversion efficiency (for example, see Patent Documents 1 to 3). For example, a CIGS solar cell has a structure in which a film including four types of semiconductor materials, namely, Cu, In, Ga, and Se is used as a light absorbing layer (photoelectric conversion layer).

In a CIGS solar cell or a CZTS solar cell, since it is possible to reduce the thickness of the light absorbing layer compared to a conventional solar cell, it is easy to install the CIGS solar cell on a curved surface and to transport the CIGS solar cell. For this reason, it is expected that CIGS solar cells can be used in various application fields as a high-performance, flexible solar cell. As a method of forming the light absorbing layer, a method of forming the light absorbing layer through depositing or sputtering is conventionally known (for example, see Patent Documents 2 to 5).

### DOCUMENTS OF RELATED ART

### Patent Documents

[Patent Document 1] Japanese Unexamined Patent Application, First Publication No. Hei 11-340482

[Patent Document 2] Japanese Unexamined Patent Application, First Publication No. 2005-51224

[Patent Document 3] Published Japanese Translation No. 2009-537997 of the PCT International Publication

[Patent Document 4] Japanese Unexamined Patent Application, First Publication No. Hei 1-231313

[Patent Document 5] Japanese Unexamined Patent Application, First Publication No. Hei 11-273783

[Patent Document 6] Japanese Unexamined Patent Application, First Publication No. 2005-175344

By contrast, as the method of forming the light absorbing layer, the present inventor propose a method of coating the semiconductor materials in the form of a liquid material on a substrate. In such a method of forming the light absorbing layer by coating the semiconductor materials in the form of a liquid material, the following problems arise.

Among the semiconductor materials, Cu, In, and the like are metals susceptible to oxidation (i.e., oxidizable metals). When a liquid material including such oxidized metals is coated on the substrate under the conditions in which the oxygen concentration or humidity is high, the oxidizable metal is likely to be oxidized, which may cause deterioration in the film quality of the coating film. This problem is not limited to the case of forming a semiconductor film of a CIGS solar cell, but may generally arise in a coating operation using a liquid material including the oxidizable metals.

In order to solve the above-described problem, for example, as described in Patent Document 6, a technology has been proposed in which a main chamber is maintained in a hermetic state by a nitrogen-circulation cleaning unit and nitrogen is circulated via a high-performance filter so as to maintain a clean state. However, since a coating operation is performed using an organic material such as a photoresist as a target solution and metal is not a main component thereof, it is difficult to solve the above-described problem.

### SUMMARY OF THE INVENTION

The present invention takes the above circumstances into consideration, with an object of providing a coating apparatus and a coating method capable of suppressing the deterioration in film quality of a coating film including oxidizable metal.

The coating method according to the present invention includes coating a liquid material including an oxidizable metal on a substrate a plurality of times to laminate a plurality of liquid material layers on the substrate (coating step); and adjusting at least one of oxygen concentration and humidity inside a chamber having a coating space in which the coating part applies the liquid material on the substrate and a transport space into which the liquid material is transported (adjusting step).

According to the present invention, at least one of oxygen concentration and humidity inside a chamber having a coating space in which the coating part applies the liquid material on the substrate and a transport space into which the liquid material is transported is adjusted while coating a liquid material including an, oxidizable metal on a substrate a plurality of times to laminate a plurality of liquid material layers on the substrate. As a result, oxidation of the oxidizable metal can be prevented. For example, when a liquid material is coated on a substrate a plurality of times, the possibility of oxidization of the oxidizable metal increases, as the number of coating operations increases. In contrast, in the present invention, since at least one of the oxygen concentration and the humidity inside the chamber is adjusted, even when the coating operation using the liquid material is performed a plurality of times, it is possible to suppress the oxidization of the oxidizable metal to the utmost. As a result, it is possible to prevent the deterioration in film quality of the coating film.

In the coating method, the coating step may include forming a dopant layer between the plurality of liquid material layers.

In this embodiment, by forming a dopant layer between the plurality of liquid material layers, it is possible to reliably allow the dopant material to permeate into the liquid material layers.

In the coating method, the coating step may include coating a plurality of liquid materials having different metal compositions.

In this embodiment, by virtue of coating a plurality of liquid materials having different metal compositions, it is possible to prevent oxidation of metals having different compositions.

In the coating method, the coating step may include drying surfaces of the plurality of liquid material layers (drying step).

In this embodiment, by virtue of drying surfaces of the plurality of liquid material layers, it is possible to efficiently treat the liquid material layers.

In the coating method, the coating step may be performed while moving the substrate.

In this embodiment, by virtue of performing the coating step while moving the substrate, it is possible to form the liquid material layers even on a substrate having a large area in a short time.

In the coating method, the metal may include at least one of copper, indium, gallium, and selenium.

In this embodiment, it is possible to reliably prevent the oxidization of the metal including at least one of copper, indium, gallium, and selenium. As a result, it is possible to prevent the deterioration in film quality of the liquid material layer.

The coating apparatus according to the present invention includes a plurality of coating parts which apply a liquid material including an oxidizable metal on a substrate; a chamber having a coating space in which the coating part applies the liquid material on the substrate and a transport space into which the liquid material is transported; and an adjusting part which adjusts at least one of oxygen concentration and humidity inside the chamber.

According to the present invention, at least one of oxygen concentration and humidity inside a chamber having a coating space in which the coating part applies the liquid material on the substrate and a transport space into which the liquid material is transported is adjusted while coating a liquid material including an, oxidizable metal on a substrate using a plurality of coating parts to laminate a plurality of liquid material layers on the substrate. As a result, oxidation of the oxidizable metal can be prevented. For example, when a liquid material is coated on a substrate a plurality of times using the plurality of coating parts, the possibility of oxidization of the oxidizable metal increases, as the number of coating operations increases. In contrast, in the present invention, since at least one of the oxygen concentration and the humidity inside the chamber is adjusted, even when the coating operation using the liquid material is performed a plurality of times, it is possible to suppress the oxidization of the oxidizable metal to the utmost. As a result, it is possible to prevent the deterioration in film quality of the coating film.

In the coating apparatus, the plurality of coating parts may include a second coating part which coats dopant on the substrate.

In this embodiment, a dopant layer can be formed between the plurality of liquid material layers, and hence, it becomes possible to reliably allow the dopant material to permeate into the liquid material layers.

In the coating apparatus, the plurality of coating parts may be capable of coating a plurality of liquid materials having different metal compositions.

In this embodiment, even when a plurality of liquid materials having different metal compositions are used, it is possible to prevent oxidation of metals having different compositions.

The coating apparatus may further include a drying mechanism which dries a surface of the liquid material coated on the substrate.

In this embodiment, by including a drying mechanism, application and drying of the liquid material can be efficiently performed.

The coating apparatus may further include a transporting mechanism which transports the substrate in a predetermined transporting direction, and the plurality of coating parts may be arranged along the transporting direction.

In this embodiment, by virtue of including a transporting mechanism which transports the substrate in a predetermined transporting direction and arranging the plurality of coating parts along the transporting direction, the coating operation using a plurality of coating parts can be performed smoothly.

In the coating apparatus, a plurality of the drying mechanisms may be arranged in the transporting direction, and the plurality of coating parts and the plurality of drying mechanisms may be alternately arranged in a moving direction of the substrate.

In this embodiment, by virtue of arranging a plurality of the drying mechanisms in the transporting direction, and alternately arranging the plurality of coating parts and the plurality of drying mechanisms in a moving direction of the substrate, the coating operation and the drying operation can be performed in accordance with the movement of the substrate. As a result, an efficient treatment can be performed.

In the coating apparatus, each of the drying mechanisms may be disposed at a position deviated from one of the plurality of coating parts in plan view.

In this embodiment, by virtue of disposing each of the drying mechanisms at a position deviated from one of the plurality of coating parts in plan view, the liquid material at the coating part can be prevented from being affected by the drying operation of the drying mechanism. As a result, it is possible to prevent the liquid material from exhibiting high viscosity and solidifying. Also, it is possible to prevent degeneration of the liquid material including the oxidizable metals.

In the coating apparatus, the chamber may include partition members which partition the inside of the chamber into a plurality of sections each including one coating part and one drying mechanism.

In this embodiment, the substrate can be treated in each section including one coating part and one drying mechanism. In addition, for example, only the section which requires maintenance can be treated, so that maintenance can be performed efficiently.

In the coating apparatus, the chamber may include a second partition member which partitions one of the plurality of sections to separate the coating part and the drying mechanism.

In this embodiment, by using a second partition member to partition a section to separate the coating part and the drying mechanism, the coating operation and the drying operation can be independently performed in individual sections. As a result, the treatment conditions can be adjusted depending on the treatment to be performed. In addition, for example, only the section which requires maintenance can be treated, so that maintenance can be performed efficiently.

In the coating apparatus, the metal may include at least one of copper, indium, gallium, and selenium.

In this embodiment, it is possible to reliably prevent the oxidization of the metal including at least one of copper, indium, gallium, and selenium. As a result, it is possible to prevent the deterioration in film quality of the liquid material layer.

In the coating method, after the coating step, the plurality of the liquid material layers may be baked by performing a heating step.

In this embodiment, by baking the plurality of the liquid material layers after the coating step, the film quality can be improved.

In the coating method, after the heating step, a cooling step for cooling the substrate may be performed.

In this embodiment, by cooling the substrate after the heating step, the temperature of the substrate can be efficiently adjusted.

The coating apparatus may further include a heating mechanism for baking the liquid material on the substrate.

In this embodiment, by including a heating mechanism for baking the liquid material on the substrate, the film quality can be improved.

The coating apparatus may further include a cooling mechanism for cooling the substrate which has been heated by the heating mechanism.

In this embodiment, by including a cooling mechanism for cooling the substrate which has been heated by the heating mechanism, the temperature of the substrate can be efficiently adjusted.

In the coating apparatus, the chamber may have a plurality of accommodation rooms capable of accommodating the substrate, and the heating mechanism and the cooling mechanism may be accommodated in separate accommodation rooms.

In this embodiment, since the chamber has a plurality of accommodation rooms capable of accommodating the substrate, and the heating mechanism and the cooling mechanism are accommodated in separate accommodation rooms, the temperature of the substrate can be easily adjusted in individually in each of the accommodation rooms.

In the coating apparatus, the coating part may be provided with a nozzle which is accommodated in an accommodation room other than the accommodation rooms having the heating mechanism and the cooling mechanism accommodated.

In this embodiment, since the coating part is proved with a nozzle which is accommodated in an accommodation room other than the accommodation rooms having the heating mechanism and the cooling mechanism accommodated, the liquid material can be ejected to the substrate without being affected by the change in the temperature of the substrate.

Thus, according to the present invention, it is possible to suppress the deterioration in film quality of a coating film containing an oxidizable metal.

### BRIEF DESCRIPTION OF THE DRAWINGS

FIG. 1 is a diagram showing a configuration of a coating apparatus according to one embodiment of the present invention.

FIG. 2 is a diagram showing a configuration of a part of the coating apparatus according to one embodiment of the present invention.

FIG. 3 is a diagram showing an operation of the coating apparatus according to one embodiment of the present invention.

FIG. 4 is a diagram showing an operation of the coating apparatus according to one embodiment of the present invention.

FIG. 5 is a diagram showing an operation of the coating apparatus according to one embodiment of the present invention.

FIG. 6 is a diagram showing an operation of the coating apparatus according to one embodiment of the present invention.

FIG. 7 is a diagram showing an operation of the coating apparatus according to one embodiment of the present invention.

FIG. 8 is a diagram showing an, operation of the coating apparatus according to one embodiment of the present invention.

FIG. 9 is a diagram showing an operation of the coating apparatus according to one embodiment of the present invention.

FIG. 10 is a diagram showing an operation of the coating apparatus according to one embodiment of the present invention.

FIG. 11 is a diagram showing a configuration of a coating apparatus according to another embodiment of the present invention.

FIG. 12 is a diagram showing a configuration of a coating apparatus according to still another embodiment of the present invention.

FIG. 13 is a diagram showing a configuration of a coating apparatus according to a second aspect of the present invention.

FIG. 14 is a diagram showing a configuration of a coating apparatus according to another embodiment of the second aspect of the present invention.

FIG. 15 is a diagram showing a configuration of a coating apparatus according to a third aspect of the present invention.

### DETAILED DESCRIPTION OF THE INVENTION

Hereinafter, one embodiment of the present invention will be described with reference to the accompanying drawings.

In the respective drawings as below, upon describing the configuration of a coating apparatus, for the purpose of simple marking, an XYZ coordinate system is used to describe the directions in the drawings. In the XYZ coordinate system, the horizontal direction in the drawing is marked as the X direction, and the direction perpendicular to the X direction in a plan view is marked as the Y direction. The direction perpendicular to a plane including the X and Y axes is marked as the Z direction. In the X, Y, and Z directions, the arrow direction in the drawing is the +direction, and the opposite direction of the arrow direction is the −direction.

[Coating Apparatus]

FIG. 1 is a schematic diagram showing a configuration of a coating apparatus CTR according to one embodiment of the present invention.

As shown in FIG. 1, the coating apparatus CTR includes a chamber CB, a coating part CT, a application condition adjusting part AC, a drying part DR, a substrate transporting part TR, and a control device CONT. The coating apparatus CTR is an apparatus which applies a liquid material on a substrate S inside the chamber CB.

In this embodiment, as the liquid material, for example, a liquid composition is used which includes a solvent such as hydrazine and oxidizable metals such as copper (Cu), indium (In), gallium (Ga), and selenium (Se). The liquid composition includes a metal material for forming a light absorbing layer (photoelectric conversion layer) of a CIGS solar cell. In this embodiment, as another liquid material, a liquid composition including sodium (Na) dispersed in a solvent such as hydrazine is used. The liquid composition contains a substance for obtaining the grain size of a light absorbing layer of a CIGS solar cell. Needless to say, as the liquid material, a liquid material in which another oxidizable metal is dispersed in the solution may be used. In this embodiment, as the substrate S, for example, a plate-shaped member made of glass, resin, or the like may be used.

(Chamber)

The chamber CB includes a housing 10, a substrate loading opening 11, and a substrate unloading opening 12. The housing 10 is adapted to accommodate the substrate S. The substrate loading opening 11 and the substrate unloading opening 12 are openings formed in the housing 10. The substrate loading opening 11 is formed in, for example, the −X-direction-side end portion of the housing 10. The substrate unloading opening 12 is formed in, for example, the +X-direction-side end portion of the housing 10. The substrate loading opening 11 and the substrate unloading opening 12 are connected to, for example, a load lock chamber (not shown).

The substrate loading opening 11 is provided with a shutter member 11a. The shutter member 11a is adapted to be movable in the Z direction, and is adapted to open or close the substrate loading opening 11. The substrate unloading opening 12 is provided with a shutter member 12a. In the same manner as the shutter member 11a, the shutter member 12a is adapted to be movable in the Z direction, and is adapted to open or close the substrate unloading opening 12. When the shutter members 11a and 12a are both in a closed state, the inside of the chamber CB is hermetically closed. FIG. 1 shows the state in which the shutter members 11a and 12a are closed.

(Coating Part)

The coating part CT is accommodated in the housing 10 of the chamber CB. The coating part CT includes three elongated slit nozzles NZ1 to NZ3. The slit nozzles NZ1 to NZ3 are arranged in the X direction. The slit nozzles NZ1 to NZ3 are formed to be elongated in the Y direction.

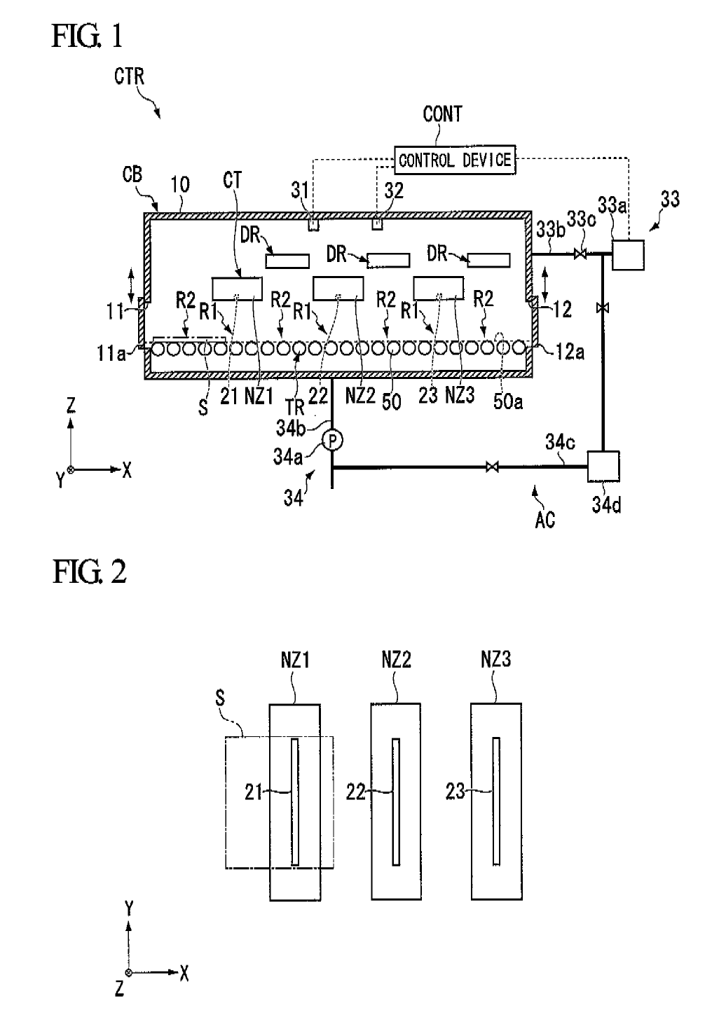

FIG. 2 is a diagram showing a configuration of the slit nozzles NZ1 to NZ3. FIG. 2 shows the configuration when the slit nozzles NZ1 to NZ3 are viewed from the −Z direction side thereof to the +Z direction side thereof.

As shown in FIG. 2, the slit nozzles NZ1 to NZ3 respectively include nozzle openings 21 to 23. The nozzle openings 21 to 23 each eject the liquid material. The nozzle openings 21 to 23 are provided in the Y direction so as to follow the longitudinal direction of the slit nozzles NZ1 to NZ3. The dimensions of the nozzle openings 21 to 23 in the longitudinal direction are formed to be substantially equal to the dimension of the substrate S in the Y direction.

The slit nozzle NZ1 ejects, for example, a liquid material in which four types of metals, namely, Cu, In, Ga, and Se are mixed with a first composition ratio. The slit nozzle NZ2 is a second coating part which ejects a liquid material containing sodium (Na). The slit nozzle NZ3 ejects a liquid material in which four types of metals, namely, Cu, In, Ga, and Se are mixed with a second composition ratio. The first and second composition ratios may be equal to each other or different from each other.

Therefore, in the coating device CTR according to the present embodiment, the slit nozzles (NZ1 and NZ3) ejecting the liquid material including the components forming the light absorbing layer and the slit nozzle (NZ3) ejecting the liquid material including the components forming a dopant layer of the light absorbing layer are alternately arranged in the X direction. The slit nozzles NZ1 to NZ3 are respectively connected to liquid material supply sources (not shown) via connection pipes (not shown).

Each of the slit nozzles NZ1 to NZ3 includes a holding portion which holds the liquid material. Each of the slit nozzles NZ1 to NZ3 includes a temperature controlling mechanism (not shown) which controls a temperature of the liquid material held by the holding portion.

(Application Condition Adjusting Part)

Returning to FIG. 1, the application condition adjusting part AC includes an oxygen concentration sensor 31, a pressure sensor 32, an inert gas supply part 33, and a discharge part 34.

The oxygen concentration sensor 31 detects the oxygen concentration inside the chamber CB, and transmits the detection result to the control device CONT. The pressure sensor 32 detects a pressure inside the chamber CB, and transmits the detection result to the control device CONT. There may be plural numbers of the oxygen concentration sensors 31 and the pressure sensors 32. In FIG. 1, the oxygen concentration sensor 31 and the pressure sensor 32 are mounted to the ceiling portion of the housing 10 of the chamber CB, although they may be provided in other portions.

The inert gas supply part 33 supplies, for example, an inert gas such as nitrogen gas or argon gas to the inside of the housing 10 of the chamber CB. The inert gas supply part 33 includes a gas supply source 33a, a conduit 33b, and a supply amount adjusting part 33c. As the gas supply source 33a, for example, a gas cylinder or the like may be used.

One end of the conduit 33b is connected to the gas supply source 33a, and the other end thereof is connected to the inside of the housing 10 of the chamber CB. The end portion of the conduit 33b connected to the chamber CB is an inert gas supply port in the chamber CB. The inert gas supply port is disposed on the +Z direction side of the housing 10.

The supply amount adjusting part 33c is a part which adjusts the amount of the inert gas supplied to the inside of the housing 10. As the supply amount adjusting part 33c, for example, an electromagnetic valve or a valve which is manually opened or closed may be used. The supply amount adjusting part 33c is provided in, for example, the conduit 33b. The supply amount adjusting part 33c may be directly installed in, for example, the gas supply source 33a, instead of disposing in the conduit 33b.

The discharge part 34 discharges a gas inside the housing 10 of the chamber CB to the outside of the housing 10. The discharge part 34 includes a discharge driving source 34a, a conduit 34b, a conduit 34c, and a removing member 34d. The discharge driving source 34a is connected to the inside of the housing 10 via the conduit 34b. As the discharge driving source 34a, for example, a pump or the like may be used. The conduit 34b has a discharge port which is provided in an end portion thereof provided inside the housing 10. The discharge port is disposed on the −Z direction side of the housing 10.

By such a configuration in which the inert gas supply port is disposed on the +Z direction side of the housing 10 and the discharge port is disposed on the −Z direction side of the housing 10, the gas inside the housing 10 flows in the −Z direction. In this manner, it is possible to suppress the gas inside the housing 10 from whirling around.

One end of the conduit 34c is connected to the discharge driving source 34a, and the other end thereof is connected to the conduit 33b of the inert gas supply part 33. The conduit 34e is used as a circulation path which circulates the gas discharged by the discharge driving source 34a from the inside of the housing 10 to the supply path. In this manner, the discharge part 34 is also used as a circulating mechanism which circulates the gas inside the housing 10. The connection portion of the conduit 34c is not limited to the conduit 33b of the inert gas supply part 33, but for example, the conduit 34c may be directly connected to the inside of the housing 10.

The removing member 34d is provided inside the conduit 34c. As the removing member 34d, for example, an absorbing material for absorbing an oxygen component and moisture contained in the gas circulating in the conduit 34c is used. In this manner, it is possible to clean the circulated gas. The removing member 34d may be disposed at one position inside the conduit 34c, or may be disposed throughout the conduit 34c.

(Drying Part)

The drying part DR is a part which dries the liquid material coated on the substrate S. The drying part DR includes a heating mechanism such as an infrared unit. The drying part DR is adapted to heat and dry the liquid material by using the heating mechanism. The drying part DR is provided at a position not overlapping with the nozzles NZ1 to NZ3 in plan view. More specifically, one drying part DR is disposed between the slit nozzles NZ1 and NZ2, another drying part DR is disposed between the slit nozzles NZ2 and NZ3, and still another drying part DR is disposed on the +X direction side of the slit nozzle NZ3. For this reason, the action of the drying part DR (e.g., irradiation of infrared ray) hardly influences the slit nozzle NZ, and thus the liquid material inside the slit nozzle NZ is hardly dried. By such a configuration in which the drying part DR is not disposed on the +Z direction side of the slit nozzle NZ, it is possible to prevent clogging of the nozzle NZ, thereby preventing a change in quality of the liquid composition including the oxidizable metal materials.

(Substrate Transporting Part)

The substrate transporting part TR is a part which transports the substrate S inside the housing 10. The substrate transporting part TR includes a plurality of roller members 50. The roller members 50 are arranged in the X direction from the substrate loading opening 11 to the substrate unloading opening 12. Each roller member 50 is adapted to be rotatable about the Y direction serving as the central axis.

The plurality of roller members 50 are formed to have the same diameter, and are disposed at the same position in the Z direction. The #Z-direction-side upper ends of the roller members 50 are adapted to support the substrate S. For this reason, the support positions of the roller members 50 are formed on the same plane, and a transporting plane 50a for the substrate S is formed by the plural roller members 50.

The transporting plane 50a for the substrate S is formed so that a loading position of the substrate S at the substrate loading opening 11 and an unloading position of the substrate S at the substrate unloading opening 12 are equal to each other in the Z direction. In this manner, the substrate S is reliably transported from the substrate loading opening 11 to the substrate unloading opening 12 without any change in the Z-direction position thereof.

In the space above the substrate transporting plane 50a inside the chamber CB, spaces on the −Z direction side of the slit nozzles NZ1 to NZ3 become coating spaces R1 where the liquid material is applied on the substrate S. In the space above the substrate transporting plane 50a inside the chamber CB, each of the spaces on the −X direction side of the slit nozzle NZ1 and +Z direction side of the slit nozzle NZ3 becomes a transport space R2 (transport space R2) where the substrate S coated with the liquid material is transported. The furthest transport space R2 in the −X-direction becomes the transport space when the substrate S is moved in the −X direction and the liquid material is coated thereon by using the slit nozzle NZ1.

(Control Device)

The control device CONT is a part which has the overall control of the coating apparatus CTR. More specifically, the control device CONT controls an opening closing operation using the shutter members 11a and 12a of the chamber CB, a transporting operation using the substrate transporting part TR, a coating operation using the coating device CT, a drying operation using the drying part DR, and an adjusting operation using the application condition adjusting part AC. As an example of the adjusting operation, the control device CONT controls an opening degree of the supply amount adjusting part 33c of the inert gas supply part 33 on the basis of the detection result obtained by the oxygen concentration sensor 31 and the pressure sensor 32.

[Coating Method]

Next, a coating method according to one embodiment of the present invention will be described. In this embodiment, a coating film is formed on the substrate S by using the coating apparatus CTR having the above-described configuration. The operations performed by the respective portions of the coating apparatus CTR are controlled by the control device CONT.

The control device CONT controls the atmosphere inside the chamber CB to be an inert gas atmosphere. More specifically, an inert gas is supplied to the inside of the chamber CB by using the inert gas supply part 33. In this case, the control device CONT may control the pressure inside the chamber CB by appropriately operating the discharge part 34.

In addition, the control device CONT controls the holding portions of the slit nozzles NZ1 to NZ3 to respectively hold the liquid materials therein. The control device CONT controls the temperature of the liquid materials respectively held by the holding portions by using the temperature controlling mechanisms inside the slit nozzles NZ1 to NZ3. In this manner, the control device CONT controls the slits nozzle NZ so as to be in a state capable of ejecting the liquid material to the substrate S.

When the coating apparatus CTR is in the state capable of ejecting the liquid material to the substrate S, the control device CONT loads the substrate S from the load lock chamber into the chamber CB. More specifically, the control device CONT moves up the shutter member 11a of the substrate loading opening 11, and loads the substrate S into the chamber CB via the substrate loading opening 11.

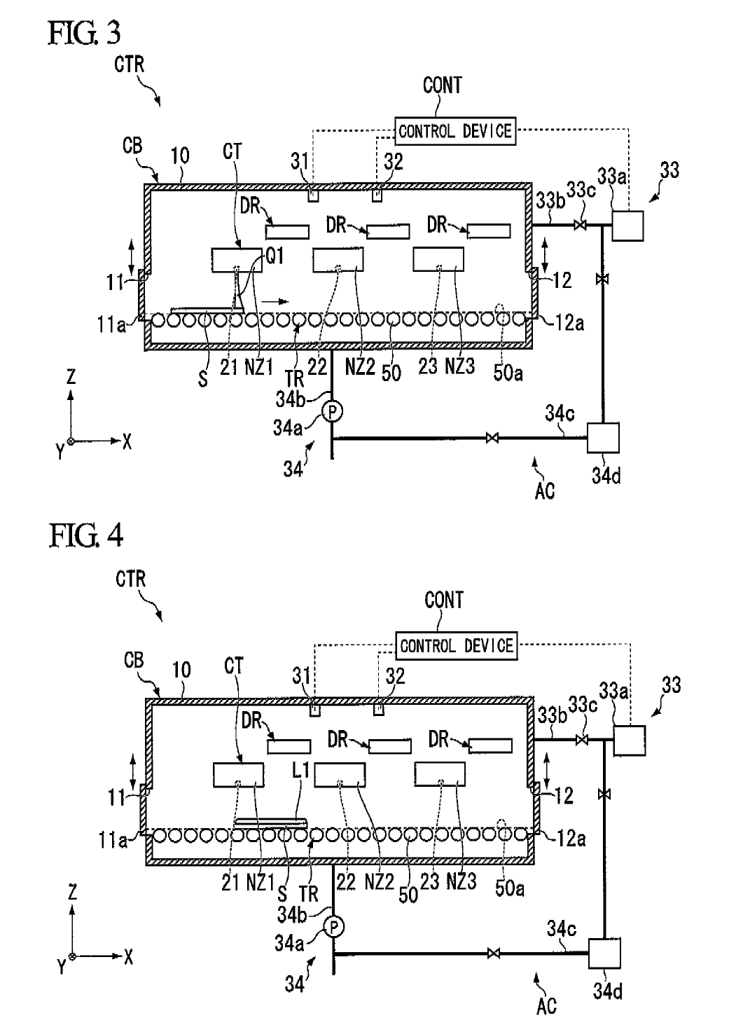

After the substrate S is loaded into the chamber CB, the control device CONT rotates the roller members 50 of the substrate transporting part TR so as to move the substrate S in the +X direction. When the +X-direction-side edge of the substrate S arrives at a position overlapping with the nozzle opening 21 of the slit nozzle NZ as viewed from the Z direction, as shown in FIG. 3, the control device CONT operates the slit nozzle NZ so as to eject a liquid material Q1 from the nozzle opening 21.

The control device CONT rotates the roller members 50 while ejecting the liquid material Q1 from the nozzle opening 21 in the state where the position of the slit nozzle NZ1 is fixed. By this operation, the liquid material is coated on the substrate S from the +X direction side thereof to the −X direction side thereof in accordance with the movement of the substrate S. As shown in FIG. 4, a first coating film L1 of the liquid material is formed on a predetermined area of the substrate S (coating step). After the first coating film L1 is formed on the substrate S, the control device CONT stops the operation of ejecting the liquid material from the nozzle opening 21.

After the ejecting operation stops, the control device CONT operates the furthest drying part DR in the −X direction amongst the three drying parts DR so as to dry the first coating film formed on the substrate S (drying step). The control device CONT, for example, stops the operation of rotating the roller members 50 after moving the substrate S to a position between the slit nozzles NZ1 and NZ2, and operates the drying part DR while the substrate S is in a stationary state. For this reason, the step of drying the substrate S is performed at a position where the first coating film L1 is deviated from the coating position. For example, the time required for drying the first coating film L1 on the substrate S and/or the drying temperature is memorized in advance, and the control device CONT performs a drying operation of the first coating film L1 by controlling the drying time and the drying temperature on the basis of the memorized values.

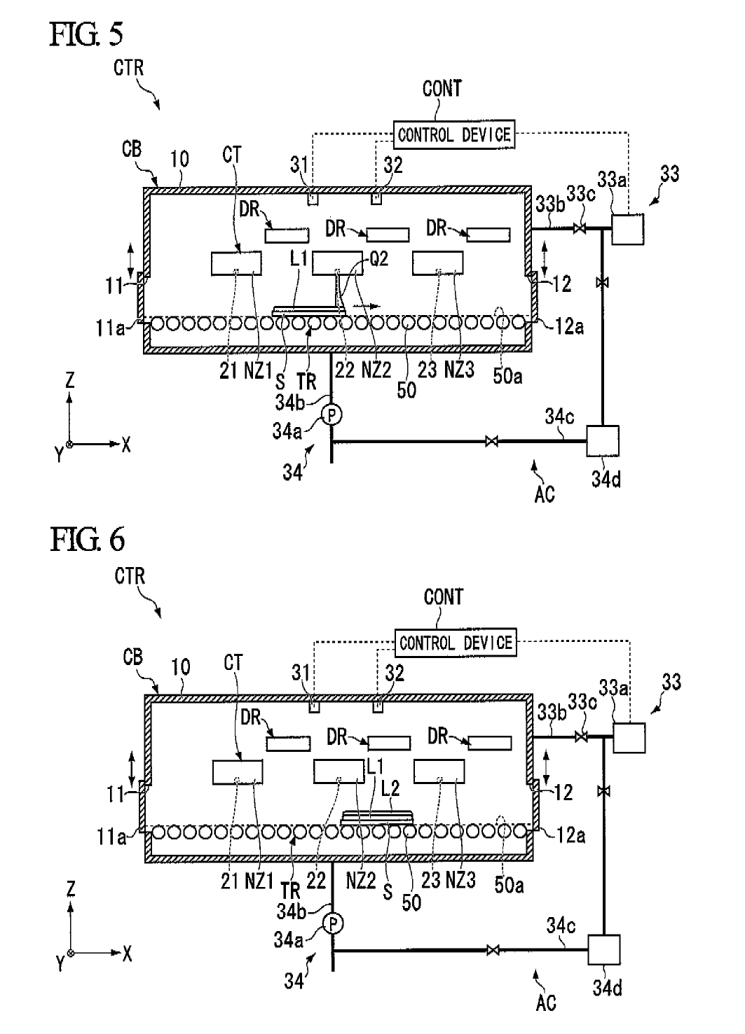

After the operation of drying the first coating film L1 ends, the control device CONT rotates the roller members 50 so as to move the substrate S in the +X direction. When the +X-direction-side edge of the substrate S arrives at a position overlapping with the nozzle opening 22 of the slit nozzle NZ2 as viewed from the Z direction, as shown in FIG. 5, the control device CONT operates the slit nozzle NZ2 so as to eject a liquid material Q2 from the nozzle opening 22.

The control device CONT, in the same manner as in the coating operation using the slit nozzle NZ2, rotates the roller members 50 while ejecting the liquid material Q2 from the nozzle opening 22 in the state where the position of the slit nozzle NZ2 is fixed. By this operation, the liquid material is coated on the first coating film L1 from the +X direction side thereof to the −X direction side thereof. As a result, as shown in FIG. 6, a second coating film L2 is formed on the first coating film L1 (dopant layer forming step). After the second coating film L2 is formed on the first coating film L1, the control device CONT stops the operation of ejecting the liquid material from the nozzle opening 22. The second coating film L2 serves as a dopant layer which supplies Na to the first coating film L1. The Na atoms inside the second coating film L2 move into the first coating film L1 so as to improve the crystallinity of the first coating film L1.

After the second coating film L2 is formed on the first coating film L1, the control device CONT rotates the roller members 50 so as to move the substrate S in the +X direction. When the substrate S arrives at a position overlapping with the nozzle opening 23 of the slit nozzle NZ3 as viewed from the Z direction, as shown in FIG. 7, the control device CONT operates the slit nozzle NZ3 so as to eject a liquid material Q3 from the nozzle opening 23. After forming the second coating film L2, a drying step may be performed using a drying part DR (the middle drying part DR amongst the three drying parts DR). In such a case, for example, after the substrate S is moved to a position between the slit nozzles NZ2 and NZ3, the drying step may be performed while the substrate S is in a stationary state.

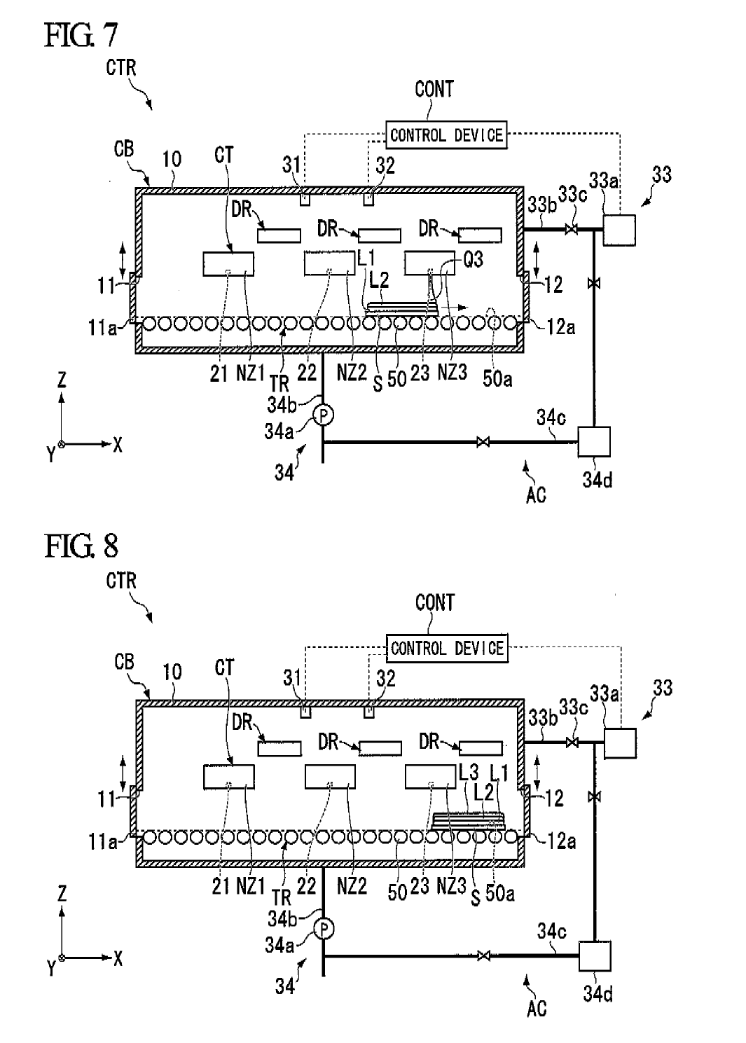

The control device CONT rotates the roller members 50 while ejecting the liquid material Q3 from the nozzle opening 21 in the state where the position of the slit nozzle NZ3 is fixed. By this operation, the liquid material Q3 is coated on the second coating film L2 in accordance with the movement of the substrate S, and as shown in FIG. 8, a third coating film L3 of the liquid material is formed on the second coating film L2. After the third coating film L3 is formed on the second coating film L2, the control device CONT stops the operation of ejecting the liquid material from the nozzle opening 23.

After the ejecting operation stops, the control device CONT operates the furthest drying part DR in the +X direction amongst the three drying parts DR so as to dry the third coating film L3. The control device CONT, in the same manner as in the drying operation of the first coating film L1, stops the rotation operation of the roller members 50 after moving the substrate S to the +X direction side of the slit nozzle NZ3, and operates the drying part DR while the substrate S is in a stationary state. For example, in the same manner as in the case of the drying time and drying temperature of the first coating film L3, the drying time and/or the drying temperature of the third coating film L3 is memorized in advance, and the control device CONT performs a drying operation of the third coating film L3 by controlling the drying time and the drying temperature on the basis of the memorized values.

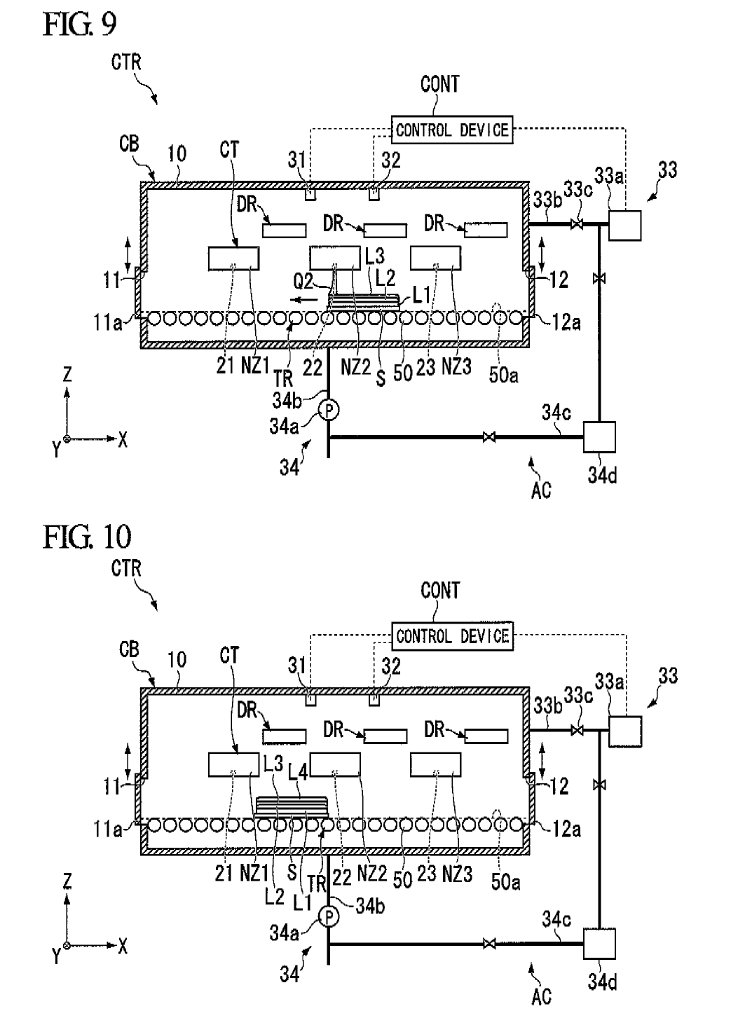

After the operation of drying the third coating film L3 ends, the control device CONT rotates the roller members 50 so as to move the substrate S in the −X direction. When the −X-direction-side edge of the substrate S arrives at a position overlapping with the nozzle opening 22 of the slit nozzle NZ2 as viewed from the Z direction, as shown in FIG. 9, the control device CONT operates the slit nozzle NZ2 so as to eject a liquid material Q2 from the nozzle opening 22.

The control device CONT rotates the roller members 50 while ejecting the liquid material from the nozzle opening 22 in the state where the position of the slit nozzle NZ22 is fixed. By this operation, the liquid material is coated on the third coating film L3 from the −X direction side thereof to the +X direction side thereof. As a result, as shown in FIG. 10, a fourth coating film L4 is formed on the third coating film L3. After the fourth coating film L4 is formed on the third coating film L3, the control device CONT stops the operation of ejecting the liquid material from the nozzle opening 22. The fourth coating film LA serves as a dopant layer which supplies Na to the third coating film L3. The Na atoms inside the fourth coating film L4 move into the third coating film L3 so as to improve the crystallinity of the third coating film L3.

Subsequently, for example, the control device CONT moves down any one of the slit nozzles NZ1 and NZ3 (in the −Z direction), and coats the liquid material Q1 or the liquid material Q3 on the fourth coating film L4 so as to form a fifth coating film (not shown) thereon. After the fifth coating film is formed thereon, the control device CONT ejects the liquid material Q2 from the slit nozzle ND onto the fifth coating film so as to form a sixth coating film thereon. By repeating theses operations, a light absorbing layer is formed an the substrate S.

In the case where a light absorbing layer is formed by coating the liquid materials Q1 and Q3 having the four types of semiconductor materials dispersed therein on the substrate S, for example, since Cu, In, Ga, Se and the like are metals which are susceptible to oxidation (oxidizable metals), when the oxygen concentration inside the chamber CB is high, the oxidizable metals are oxidized. When the metals are oxidized, the film quality of the coating film formed on the substrate S may deteriorate.

In the present embodiment, the control device CONT controls the oxygen concentration inside the chamber CB by using the application condition adjusting part AC (adjusting step). More specifically, the control device CONT supplies an inert gas to the inside of the chamber CB by using the inert gas supply part 33.

In the inert gas supplying step, the control device CONT first detects the oxygen concentration inside the chamber CB by using the oxygen concentration sensor 31. The control device CONT adjusts the inert gas supply amount by using the supply amount adjusting part 33c on the basis of the detection result obtained in the detecting step, and supplies the inert gas to the inside of the chamber CB. For example, when the detected oxygen concentration exceeds a predetermined threshold value, it is possible to supply the inert gas into the chamber CB. The threshold value may be obtained in advance by a test or simulation, and may be stored in the control device CONT. In addition, for example, a predetermined amount of the inert gas may be constantly supplied into the chamber CB during the coating operation and the drying operation, and the inert gas supply amount can be increased or decreased on the basis of the detection result of the oxygen concentration sensor 31.

In the inert gas supplying step, the control device CONT uses the oxygen concentration sensor 31, and also detects the atmospheric pressure inside the chamber CB by using the pressure sensor 32. The control device CONT adjusts the inert gas supply amount by using the supply amount adjusting part 33c on the basis of the detection result obtained in the second detection step, and supplies the inert gas into the chamber CB. For example, when the atmospheric pressure inside the chamber CB exceeds a predetermined threshold value, the gas inside the chamber CB is discharged by using the discharge part 34. This threshold value may be obtained in advance by a test or simulation, and may be stored in the control device CONT. In addition, for example, a predetermined amount of the gas inside the chamber CB may be constantly discharged during the coating operation and the drying operation, and the discharge amount can be increased or decreased on the basis of the detection result of the pressure sensor 32.

The gas discharged from the discharge part 34 is circulated to the conduit 33b of the inert gas supply part 33 via the conduits 34b and 34c. When the gas flows through the conduit 34c, the gas passes through the removing member 34d. When the gas passes through the removing member 34d, the oxygen component in the gas is adsorbed by the removing member 34d so as to be removed from the gas. In this manner, an inert gas having a low oxygen concentration is circulated to the conduit 33b. By circulating the gas inside the chamber CB, it becomes possible to supply the inert gas under stable temperature conditions.

As described above, according to the present embodiment, since the oxygen concentration inside the chamber CB can be suppressed by using the application condition adjusting part AC which adjusts the oxygen concentration inside the chamber CB, it is possible to prevent the oxidization of the liquid materials Q1 and Q3 or the oxidizable metals included in the liquid materials Q1 and Q3. As a result, it is possible to prevent the deterioration in film quality of the coating film.

In addition, as in the present embodiment, when the liquid materials Q1 and Q3 are coated on the substrate S a plurality of times, the possibility of the oxidization of the oxidizable metal increases as the number of coating operations increases. In contrast, in the present embodiment, by controlling the oxygen concentration inside the chamber CB, even when the coating operation using the liquid materials Q1 and Q3 is performed a plurality of times, it is possible to suppress the oxidization of the oxidizable metal to the utmost. As a result, it is possible to more reliably suppress the deterioration in film quality of the coating film.

Further, according to the present embodiment, in the coating step, since the coating films L2 and L4 as the dopant layers are formed between the coating films L1 and L3 of the liquid material including the oxidizable metal, it is possible to increase the grain size of the coating films L1 and L3, and thus to obtain the high-quality coating film.

The technical scope of the present invention is not limited to the above-described embodiment, but may be appropriately modified into various forms without departing from the spirit of the present invention.

For example, in the above-described embodiment, the drying parts DR are arranged in series along the slit nozzles NZ1 to NZ3 in the X direction, but the present invention is not limited thereto. For example, the drying parts DR may be selectively disposed at a space between the slit nozzles NZ1 and NZ2, a space between the slit nozzles NZ2 and the NZ3, a space on the −X direction side of the slit nozzle NZ1, and a space on the +X direction side of the slit nozzle NZ3, where theses spaces correspond to the transport spaces R2 used after the coating operation.

Further, in the above-described embodiment, the oxygen concentration inside the chamber CB is detected so that the inert gas supply amount is controlled on the basis of the detection result, but the present invention is not limited thereto. For example, the humidity inside the chamber CB may be detected so as to control the inert gas supply amount on the basis of the detected humidity. In this case, for example, the chamber CB is provided with a humidity sensor in addition to the oxygen concentration sensor 31. Alternatively, a humidity sensor may be disposed instead of the oxygen concentration sensor 31. In this case, it is desirable that an absorbing material for absorbing the moisture in the gas be provided as the removing member 34d.

In the above-described embodiment, the coating part CT includes the slit nozzles NZ1 to NZ3, but the present invention is not limited thereto. For example, a dispenser coating part or an ink jet coating part may be used. Alternatively, for example, the liquid material disposed on the substrate S may be diffused by using a squeezer or the like so as to be coated thereon. Further, the slit nozzle NZ2 may be substituted with a spray-type coating part.

In the above-described embodiment, the slit nozzles NZ1 to NZ3 constituting the coating part CT is fixed, but the present invention is not limited thereto. For example, a moving mechanism for moving the slit nozzles NZ1 to NZ3 may be provided so as to move the slit nozzles.

In the above-described embodiment, the roller members 50 are used as the substrate transporting part TR, but the present invention is not limited thereto. For example, the substrate S may be transported by using a floating mechanism to lift the substrate S. In this case, the floating mechanism may be selectively disposed in an area where the slit nozzles NZ1 to NZ3 are disposed inside the chamber CB. By such a configuration, it is possible to precisely control the film thickness of the coating film formed on the substrate S.

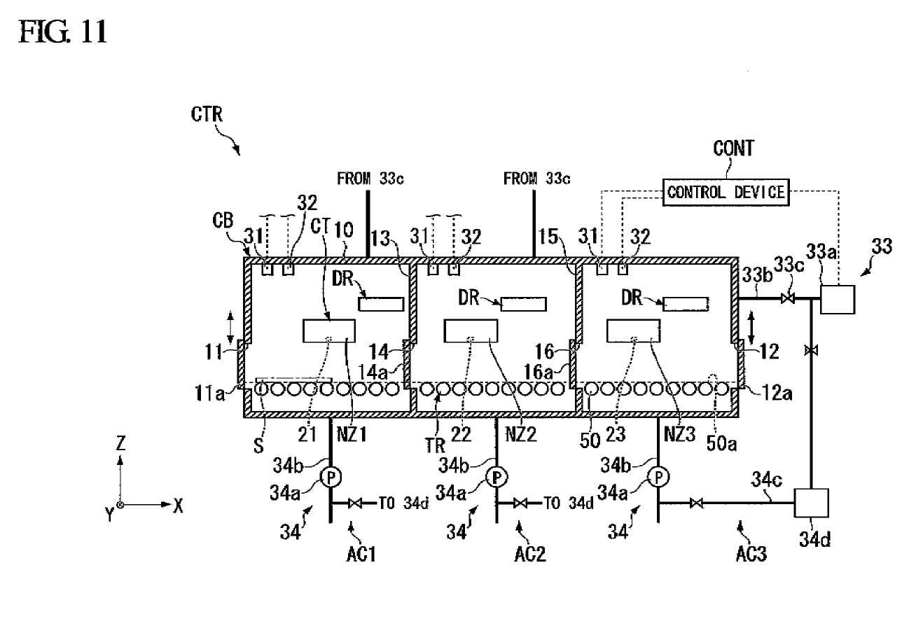

In the above-described embodiment, the slit nozzles NZ1 to NZ3 and three drying parts DR are disposed in one section inside the chamber CB, but the invention is not limited thereto. For example, as shown in FIG. 11, the space inside the chamber CB may be partitioned so that one slit nozzle and one drying part are include in each partitioned section. In this case, as shown in FIG. 11, partition members 13 and 15 are disposed inside the chamber CB so as to form three sections inside the chamber CB. The 3 sections are respectively provided with application condition adjusting parts AC1 to AC3. The application condition adjusting parts AC1 to AC3 are formed to have the same configuration as, for example, the application condition adjusting part AC described in the aforementioned embodiment. In FIG. 11, for easy understanding of the drawing, the configuration of the application condition adjusting part AC3 is representatively shown, and the configurations of the application condition adjusting parts AC1 and AC2 are partially omitted.

The partition members 13 and 15 are arranged along the transporting direction of the substrate S. Therefore, the substrate S is transported so as to pass through the partition members 13 and 15. For example, the partition members 13 and 15 are respectively provided with openings 14 and 16 formed in a region corresponding to the height position (a position in the Z direction) of the substrate S. The openings 14 and 16 are respectively provided with cover portions 14a and 16a so as to open or close the openings 14 and 16. When transporting the substrate S, the cover portions 14a and 16a are in an open state while the substrate S passes through the partition members 13 and 15. When the substrate S does not pass through the partition members 13 and 15 or a process is being performed in each section, the cover portions 14a and 16a are in a closed state.

By such a configuration in which the substrate S is processed in each section including one slit nozzle and one drying part, for example, it becomes possible to selectively handle the section requiring maintenance, so that maintenance can be performed efficiently.

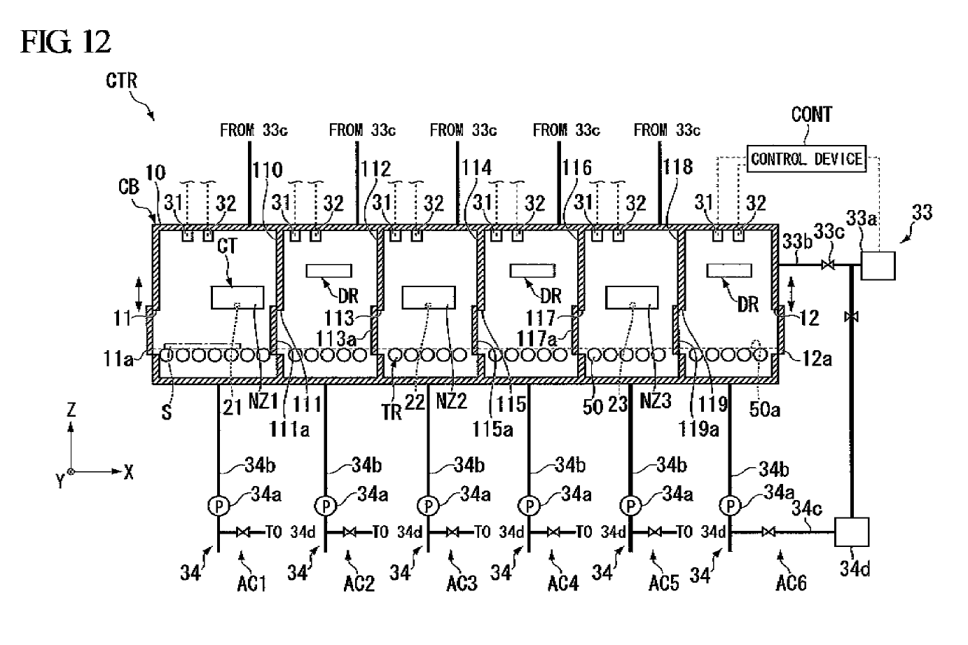

In addition, as another configuration in which the inside of the chamber CB is partitioned into a plurality of sections, a configuration shown in FIG. 12 may be adopted. Specifically, the inside of the chamber CB is partitioned into six sections so that each section includes only one of the slit nozzles NZ1 to NZ3 and three drying parts DR. The six sections are respectively provided with the application condition adjusting parts AC1 to AC6. The 6 sections are respectively provided with application condition adjusting parts AC1 to AC6. The application condition adjusting parts AC1 to AC6 are formed to have the same configuration as for example, the application condition adjusting part AC described in the aforementioned embodiment. In FIG. 12, for easy understanding of the drawing, the configuration of the application condition adjusting part AC6 is representatively shown, and the configurations of the application condition adjusting parts AC1 to AC5 are partially omitted.

The partition members 110, 112, 114, 116, and 118 are arranged along the transporting direction of the substrate S. Therefore, the substrate S is transported so as to pass through the partition members 110, 112, 114, 116, and 118. The partition members 110, 112, 114, 116, and 118 are respectively provided with openings 111, 113, 115, 117, and 119, and the openings are respectively provided with cover portions 111a, 113a, 115a, 117a, and 119a. In this configuration, each section including one of the slit nozzles NZ1 to NZ3 and one drying part DR as shown in the configuration of FIG. 11 is further partitioned.

Since each section is partitioned so as to include only one of the slit nozzles NZ1 to NZ3 and the drying parts DR, it is possible to control the treatment conditions for each treatment. In addition, for example, only the section which requires maintenance can be treated, so that maintenance can be performed efficiently.

Next, a second aspect of the present invention will be described,

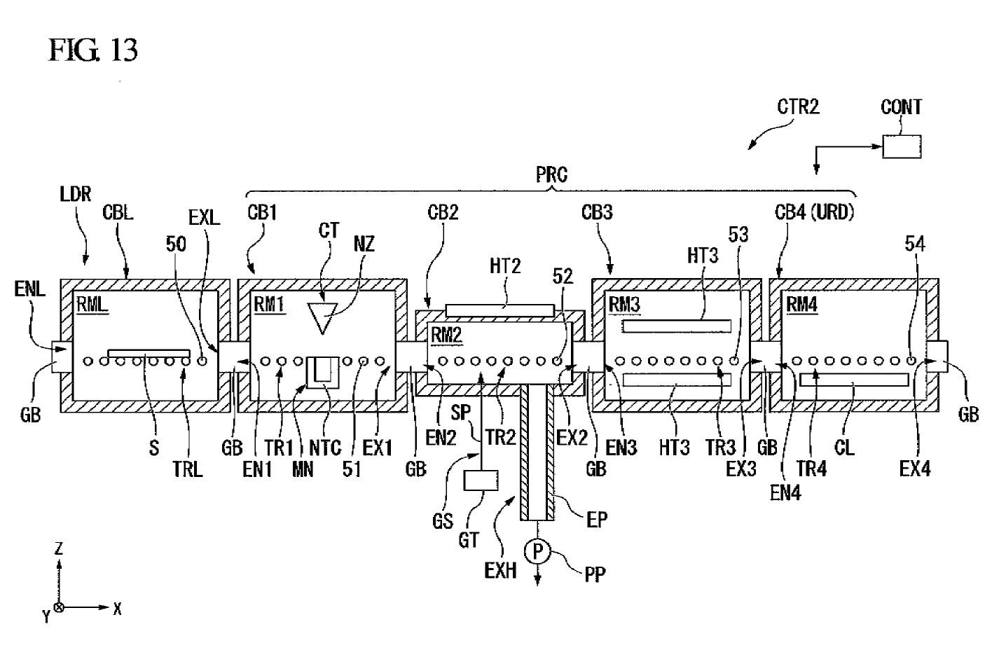

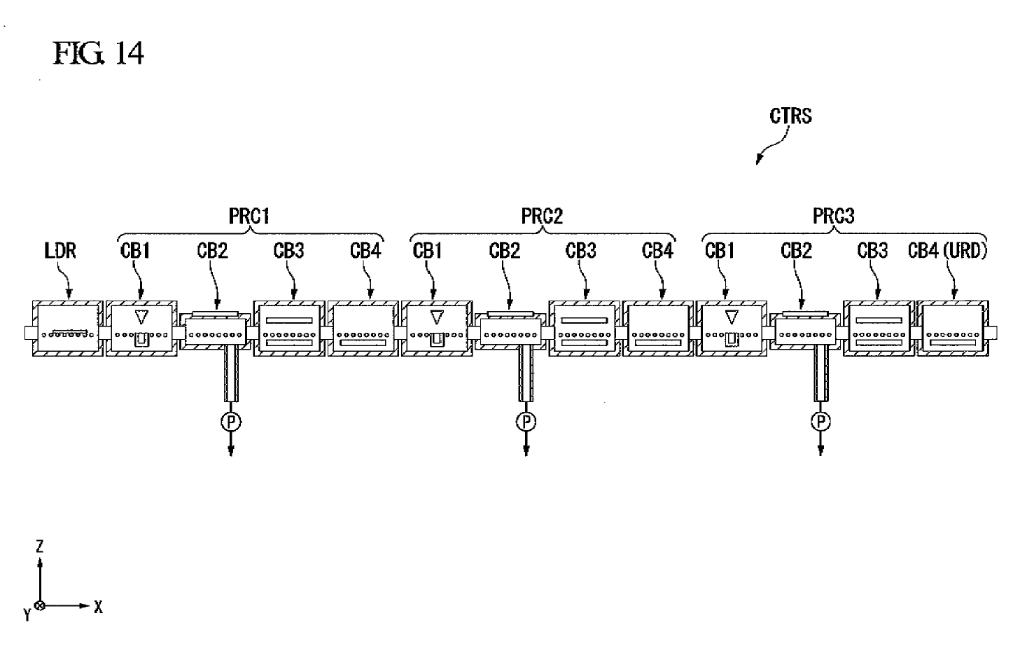

FIG. 13 is a diagram showing a configuration of a coating apparatus according to a second aspect of the present invention. As shown in FIG. 13, the coating apparatus CTR2 has a substrate loading part LDR and a substrate treating part PRC.

In FIG. 13, an XYZ coordinate system is used to describe the directions in the drawings. In the XYZ coordinate system, the horizontal direction in the drawing is marked as the X direction, and the direction perpendicular to the X direction in a plan view is marked as the Y direction. The direction perpendicular to a plane including the X and Y axes is marked as the Z direction. In the X, Y, and Z directions, the arrow direction in the drawing is the +direction, and the opposite direction of the arrow direction is the −direction.

The substrate loading part LDR has an anti-locking chamber device CBL. The anti-locking chamber device CBL has an accommodation room RML, a substrate loading opening ENL and a substrate unloading opening EXL. The substrate loading opening ENL is formed on the wall portion on the −X side of the accommodation room RML, and, for example, communicates to the outside. The substrate unloading opening EXL is formed on the wall portion of the +X side of the accommodation room RML. The substrate loading opening ENL and the substrate unloading opening EXL are formed to have a size which allows the substrate S to pass through. The accommodation room RML is provided with a substrate transporting mechanism TRL for transporting the substrate S. The substrate transporting mechanism TRL transports the substrate S inside the accommodation room RML.

The substrate transporting mechanism TRL includes a plurality of roller members 50. The roller members 50 are arranged in the X direction from the substrate loading opening ENL to the substrate unloading opening EXL. Each roller member 50 is adapted to be rotatable about the Y direction serving as the central axis. The plurality of roller members 50 are formed to have the same diameter, and are disposed at the same position in the Z direction. The +Z-direction-side upper ends of the roller members 50 are adapted to support the substrate S.

The rotation of each roller member 50 is controlled, for example, by a roller-rotation control part (not shown). As the substrate transporting mechanism TRL, a roller-type transporting mechanism as shown in FIG. 13 may be used. Alternatively, a floating mechanism (not shown) may be used to lift the substrate for transportation.

Each of the substrate loading opening ENL and the substrate unloading opening EXL is provided with a gate valve GB. For example, the gate valve GB is provided so that the substrate loading opening ENL and the substrate unloading opening EXL can be opened or closed by sliding the gate valve GB in the Z direction. By closing the gate valve GB, the accommodation room RML can be hermetically closed.

The substrate treating part PRC has a first chamber device CB1, a second chamber device CB2, a third chamber device CB3 and a fourth chamber device CB4. The first chamber device CB1, the second chamber device CB2, the third chamber device CB3 and the fourth chamber device CB4 may be connected in series in the X direction.

The first chamber device CB1 includes an accommodation room RM1, a substrate loading opening EN1 and a substrate unloading opening EX1. The accommodation room RM1 is adapted to accommodate the substrate S. The substrate loading opening EN1 and the substrate unloading opening EX1 are openings formed in the accommodation room RM1. The substrate loading opening EN1 is formed in, for example, the −X-direction-side end portion of the accommodation room RM1, and is connected to the anti-lock chamber device CBL. The substrate unloading opening EX1 is formed in for example, the +X-direction-side end portion of the accommodation room RM1, and is connected to the second chamber device CB2. The substrate loading opening EN1 and the substrate unloading opening EX1 are openings formed to have a size which allows the substrate S to pass through.

Each of the substrate loading opening EN1 and the substrate unloading opening EX1 are provided with a gate valve GB. For example, the gate valve GB is provided so that the substrate loading opening EN1 and the substrate unloading opening EX1 can be opened or closed by sliding the gate valve GB in the Z direction. By closing the gate valve GB, the accommodation room RM1 can be hermetically closed.

The accommodation room RM1 is provided with a substrate transporting mechanism TR1, a coating part CT and a maintenance part MN. The substrate transporting mechanism TR1 is a part which transports the substrate S inside the accommodation room RM1. The substrate transporting mechanism TR1 includes a plurality of roller members 51. The roller members 51 are arranged in the X direction from the substrate loading opening EN1 to the substrate unloading opening EX1. The rotation of each roller member 51 is controlled, for example, by a roller-rotation control part (not shown). Like in the case of the substrate transporting mechanism TRL, as the substrate transporting mechanism TRI, a roller-type transporting mechanism may be used, or a floating mechanism may be used to lift the substrate for transportation.

The coating part CT is accommodated in the first chamber device CB1 of the accommodation room RM1. The coating part CT includes a slit nozzle NZ which is formed in an elongated shape. The slit nozzle NZ is provided in the accommodation room RM1, for example, at a middle portion between the substrate loading opening EN1 and the substrate unloading opening EX1 in the X direction. The slit nozzle NZ is formed to be elongated in, for example, the Y direction. The slit nozzle NZ is disposed, for example, at a middle portion in the X direction of the accommodation room RM1. On each of the +X side and −X side of the slit nozzle, a space sufficient for disposing the substrate S is ensured.

The maintenance part MN has, for example, a nozzle-tip control unit NTC which controls the tip of the nozzle NZ. The nozzle-tip control unit NTC is adapted to be movable inside the accommodation room RM1. In order to improve the coating precision of the coating part CT, the nozzle-tip control unit NTC controls the tip portion of the nozzle NZ to be in the best state, e.g., removing foreign matter attached to the tip portion of the nozzle NZ. The nozzle-tip control unit NTC is adapted, for example, to be movable along the transport path of the substrate S.

The second chamber device CB2 includes an accommodation room RM2, a substrate loading opening EN2 and a substrate unloading opening EX2. The accommodation room RM2 is adapted to accommodate the substrate S. The substrate loading opening EN2 and the substrate unloading opening EX2 are openings formed in the accommodation room RM2. The substrate loading opening EN2 is formed in, for example, the −X-direction-side end portion of the accommodation room RM2, and is connected to the first chamber device CB1. The substrate unloading opening EX2 is formed in, for example, the +X-direction-side end portion of the accommodation room RM2, and is connected to the third chamber device CB3. The substrate loading opening EN2 and the substrate unloading opening EX2 are openings formed to have a size which allows the substrate S to pass through.

Each of the substrate loading opening EN2 and the substrate unloading opening EX2 are provided with a gate valve GB. For example, the gate valve GB is provided so that the substrate loading opening EN2 and the substrate unloading opening EX2 can be opened or closed by sliding the gate valve GB in the Z direction. By closing the gate valve GB, the accommodation room RM2 can be hermetically closed.

The accommodation room RM2 is provided with a substrate transporting mechanism TR2, a heating part HT2, an inert gas supply part GS and an exhaust part EXH. The substrate transporting part TR2 is a part which transports the substrate S inside the accommodation room RM2. The substrate transporting part TR2 includes a plurality of roller members 52. The roller members 52 are arranged in the X direction from the substrate loading opening EN2 to the substrate unloading opening EX2. The rotation of each roller member 52 is controlled, for example, by a roller-rotation control part (not shown). Like in the case of the substrate transporting mechanism TRL, as the substrate transporting mechanism TR2, a roller-type transporting mechanism may be used or a floating mechanism may be used to lift the substrate for transportation.

The heating part HT2 is a part which heats the liquid material coated on the substrate S. The heating part HT2 includes a heating mechanism such as an infrared unit or a hot plate. By using the heating mechanism, the heating part HT2 is adapted to for example, dry the liquid material. Thus, the second chamber device CB2 has a configuration in which drying can be performed under reduced pressure.

The inert gas supply part GS supplies, for example, an inert gas such as nitrogen gas, argon gas or helium gas to the accommodation room RM2. The inert gas supply part GS includes a gas supply source GT and a gas supply conduit SP. Further, the inert gas supply part GS has a supply amount adjusting part (not shown) which adjusts the amount of inert gas supplied. As the gas supply source GT, for example, a gas cylinder or the like may be used.

The exhaust part EXH is used for exhausting the gas inside the accommodation room RM2 to reduce the pressure inside the accommodation room RM1 and the accommodation room RM2. The exhaust part EXH includes an exhaust driving source PP and a pipe EP. The exhaust driving source PP is connected to the accommodation room RM2 via the pipe EP. As the exhaust driving source EP, for example, a suction pump or the like may be used. The pipe EP has a discharge port which is provided in an end portion thereof provided inside the accommodation room RM2. The discharge port is disposed, for example, on the bottom portion (on the −Z direction side) of the accommodation room RM2.

The third chamber device CB3 includes an accommodation room RM3, a substrate loading opening EN3 and a substrate unloading opening EX3. The accommodation room RM3 is adapted to accommodate the substrate S. The substrate loading opening EN3 and the substrate unloading opening EX3 are openings formed in the accommodation room RM3. The substrate loading opening EN3 is formed in, for example, the −X-direction-side end portion of the accommodation room RM3, and is connected to the second chamber device CB2. The substrate unloading opening EX3 is formed in, for example, the +X-direction-side end portion of the accommodation room RM3, and is connected to the fourth chamber device CB4. The substrate loading opening EN3 and the substrate unloading opening EX3 are openings formed to have a size which allows the substrate S to pass through.

Each of the substrate loading opening EN3 and the substrate unloading opening EX3 are provided with a gate valve GB. For example, the gate valve GB is provided so that the substrate loading opening EN3 and the substrate unloading opening EX3 can be opened or closed by sliding the gate valve GB in the Z direction. By closing the gate valve GB, the accommodation room RM3 can be hermetically closed.

The accommodation room RM3 is provided with a substrate transporting mechanism TR3 and a heating part 3HT. The substrate transporting part TR3 is a part which transports the substrate S inside the accommodation room RM3. The substrate transporting part TR3 includes a plurality of roller members 53. The roller members 53 are arranged in the X direction from the substrate loading opening EN3 to the substrate unloading opening EX3. The rotation of each roller member 53 is controlled, for example, by a roller-rotation control part (not shown). Like in the case of the substrate transporting mechanism TRL, as the substrate transporting mechanism TR3, a roller-type transporting mechanism may be used or a floating mechanism may be used to lift the substrate for transportation.

The heating part HT3 is a part which heats the liquid material coated on the substrate S. The heating part HT3 includes a heating mechanism such as an infrared unit, a hot plate or an oven. In the heating part HT3, it is preferable to use a heating mechanism which is capable of heating stronger than the heating mechanism used in the heating part HT2. By using the heating mechanism HT3, the heating part HT3 is adapted to baking the substrate S. In the accommodation room RM3, the heating part HT3 is provided at a plurality of portions, e.g., 2 portions. Thus, in the accommodation room RM3, the heating operation can be performed to heat the substrate S at a higher temperature than the heating operation performed in the accommodation room RM2.

The fourth chamber device CB4 includes an accommodation room RM4, a substrate loading opening EN4 and a substrate unloading opening EX4. The accommodation room RM4 is adapted to accommodate the substrate S. The substrate loading opening EN4 and the substrate unloading opening EX4 are openings formed in the accommodation room RM4. The substrate loading opening EN4 is formed in, for example, the −X-direction-side end portion of the accommodation room RM4, and is connected to the third chamber device CB3. The substrate unloading opening EX4 is formed in, for example, the +X-direction-side end portion of the accommodation room RM4, and communicates to the outside. The substrate loading opening EN4 and the substrate unloading opening EX4 are openings formed to have a size which allows the substrate S to pass through.

Each of the substrate loading opening EN4 and the substrate unloading opening EX4 are provided with a gate valve GB. For example, the gate valve GB is provided so that the substrate loading opening EN4 and the substrate unloading opening EX4 can be opened or closed by sliding the gate valve GB in the Z direction. By closing the gate valve GB, the accommodation room RM4 can be hermetically closed.

The accommodation room RM4 is provided with a substrate transporting mechanism TR4 and a cooling part CL. The substrate transporting part TR4 is a part which transports the substrate S inside the accommodation room RM4. The substrate transporting part TR4 includes a plurality of roller members 54. The roller members 54 are arranged in the X direction from the substrate loading opening EN4 to the substrate unloading opening EX4. The rotation of each roller member 54 is controlled, for example, by a roller-rotation control part (not shown). Like in the case of the substrate transporting mechanism TRL, as the substrate transporting mechanism TR4, a roller-type transporting mechanism may be used, or a floating mechanism may be used to lift the substrate for transportation.

The cooling part CL is a part which cools the substrate S heated in the second chamber device CB2 and the third chamber device CB3. The cooling part CL includes a cooling mechanism such as a cooling plate which allows a refrigerant to pass through the inside thereof. By using the cooling part CL, the cooling of the substrate S can be performed in the accommodation room RM4.

The control device CONT is a part which has the overall control of the coating apparatus CTR2. Specifically, the control device CONT controls the operations of the anti-lock chamber device CBL, the first chamber device CB1, the second chamber device CB2, the third chamber device CB3 and the fourth chamber device CB4. Specific examples of the operations include opening and closing operation of the gate valve GB, transporting operation of the substrate by the substrate transporting mechanisms TRL and TR1 to TR4, coating operation of the coating part CT, heating operation of the heating parts HT2 and HT3, exhaustion operation of the exhaustion part EXH, gas supplying operation of the gas supply part GS, and cooling operation of the cooling part CL.

The coating operation of the coating apparatus CTR2 having the above configuration is performed as follows. Firstly, when the substrate is transported into the coating apparatus CTR2 from outside, the control device CONT opens the gate valve GB provided at the substrate loading opening ENL of the anti-lock chamber device CBL, and loads the substrate S through the substrate loading opening ENL into the accommodation room RML.

After loading the substrate S into the accommodation room RML, the control device CONT closes the gate valve GB provided between the anti-lock chamber device CBL and the first chamber device CB1, and opens the gate valve GB provided between the first chamber device CB1 and the second chamber device CB2. In this state, the control device CONT adjust the amount of gas supplied by the inert gas supply part GS and the amount of gas discharged by the exhaust part EXH, thereby adjusting the atmosphere inside the accommodation room RM1 and the accommodation room RM2.

In addition, the control device CONT controls the holding portion of the slit nozzle NZ to hold the liquid material therein. The control device CONT controls the temperature of the liquid material held by the holding portion by using the temperature controlling mechanism inside the slit nozzle NZ. In this manner, the control device CONT controls the slits nozzle NZ so as to be in a state capable of ejecting the liquid material to the substrate S.

When the coating apparatus CTR is in the state capable of ejecting the liquid material to the substrate S, the control device CONT opens the substrate unloading opening EXL of the anti-lock chamber device CBL and the substrate loading opening EN1 of the first chamber device CB1, and transports the substrate S from the anti-lock chamber device CBL to load the substrate S into the accommodation room RM1 of the first chamber device CB1.

After the substrate S is loaded, the control device CONT rotates the roller members 51 of the substrate transporting part TR1 so as to move the substrate S in the +X direction. When the +X-direction-side edge of the substrate S arrives at a position overlapping with the slit nozzle NZ as viewed from the Z direction, the control device CONT operates the slit nozzle NZ so as to apply the liquid material Q to the substrate S. By this operation, a coating film of the liquid material can be uniformly formed in a predetermined region of the substrate S. After the coating film is formed on the substrate S, the control device CONT stops the operation of ejecting the liquid material from the nozzle NZ.

After the ejecting operation stops, the control device CONT accommodates the substrate S having the coating film formed thereon in the accommodation room RM2 of the second chamber device CB2. Specifically, the control device CONT opens the substrate unloading opening EX1 of the accommodation room. RM1 and the substrate loading opening EN2 of the accommodation room RM2, and transports the substrate S through the substrate unloading opening EX1 and the substrate loading opening EN2 to load the substrate S into the accommodation room RM2.

After loading the substrate S into the accommodation room RM2, the control device CONT transports the substrate S to a position on the −Z side of the heating part HT2, and then operates the exhaust part EXH to reduce the pressure inside the accommodation room RM2. After the pressure inside the accommodation room RM2 has been reduced, the control device CONT operates the heating part HT2 to heat the coating film on the substrate S (drying under reduced pressure). By heating the liquid material under reduced pressure, the coating film L can be efficiently dried in a short time. The heating temperature can be controlled to be 300° C. or lower. By controlling the heating temperature to be 300° C. or lower, even when the substrate S is made of a resin material, the heat treatment can be performed without deformation of the substrate S. Hence, the substrate S can be selected from a variety of materials.

The control device CONT, for example, stops the rotation operation of the roller members 52, and operates the heating part HT2 while the substrate S is in a stationary state. For example, the time required for drying the coating film on the substrate S and/or the heating temperature is memorized in advance, and the control device CONT performs a heating operation of the coating film L by controlling the heating time and the heating temperature on the basis of the memorized values.

After the drying operation under reduced pressure, the control device CONT accommodates the substrate S in the accommodation room RM3 of the third chamber device C33. Specifically, the control device CONT opens the substrate unloading opening EX2 of the accommodation room RM2 and the substrate loading opening EN3 of the accommodation room RM3, and transports the substrate S through the substrate unloading opening EX2 and the substrate loading opening EN3 to load the substrate S into the accommodation room RM3.

After loading the substrate S into the accommodation room RM3, the control device CONT transports the substrate S to a position where the substrate S is disposed between two heating parts HT3 in the Z direction. After transporting the substrate S, the control device CONT operates the heating parts HT3 to heat (bake) the substrate S and the coating film thereon. By performing the heating operation, the state of the coating film can be stabilized.

After the heating operation, the control device CONT accommodates the substrate S in the accommodation room RM4 of the fourth chamber device CB4. Specifically, the control device CONT opens the substrate unloading opening EX3 of the accommodation room RM3 and the substrate loading opening EN4 of the accommodation room RM4, and transports the substrate S through the substrate unloading opening EX3 and the substrate loading opening EN4 to load the substrate S into the accommodation room RM4.

After loading the substrate S into the accommodation room RM4, the control device CONT transports the substrate S to a position where the substrate S is disposed above the cooling part CL in the Z direction. After transporting the substrate S, the control device CONT operates the cooling part CL to cool the substrate S and the coating film thereon. After the cooling operation, the control device CONT unloads the substrate S through the substrate unloading opening EX4.

Thus, according to the present embodiment, the coating operation, the drying operation under reduced pressure, the heating (baking) operation and the cooling operation are separately performed in different chamber devices (CB1 to CB4). As a result, conditions for the respective operations can be adjusted individually.

As shown in FIG. 14, the substrate treating part PRC of the coating apparatus CTR2 according to the present aspect can be provided in series. In such a case, the coating apparatus CTRS has a substrate loading part LDR and substrate treating parts PRC1 to PRC3. The configuration of each of the treating parts PRC1 to PRC3 is the same as the aforementioned substrate treating part PRC. Further, the fourth chamber CB4 of the substrate treating part PRC3 serves as both a cooling part and an unloading device. In this case, by transporting the substrate S in one direction (X direction), a plurality of layers can be formed on the substrate S. The first chamber devices CB1 of the substrate treating parts PRC1 to PRC3 may have a configuration in which different types of liquid materials are coated.

Next, a third aspect of the present invention will be described.

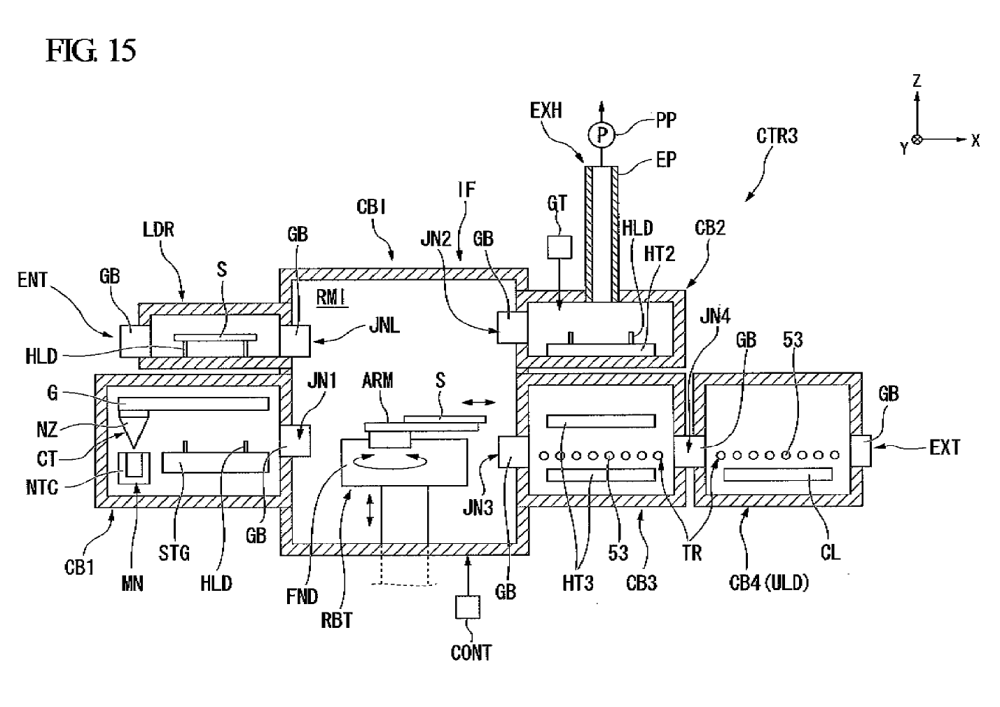

FIG. 15 is a schematic diagram showing a configuration of a coating apparatus CTR3 according to the present aspect.

In FIG. 15, like in the aforementioned embodiments, an XYZ coordinate system is used to describe the directions in the drawings. In the XYZ coordinate system, the horizontal direction in the drawing is marked as the X direction, and the direction perpendicular to the X direction in a plan view is marked as the Y direction. The direction perpendicular to a plane including the X and Y axes is marked as the Z direction. In the X, Y, and Z directions, the arrow direction in the drawing is the +direction, and the opposite direction of the arrow direction is the −direction.

In the coating apparatus CTR3 according to the present aspect, the components of the coating apparatus CTR2 according to the second aspect, namely, a substrate loading part LIAR (anti-lock chamber device CBL), a first chamber device CB1, a second chamber device CB2, a third chamber device CB3 and a fourth chamber device CB4 are connected to an interface part IF and arranged so that each component branch from the interface part IF as the center.

The interface part IF includes a common chamber device CBI. The common chamber device CBI includes an accommodation room RMI and junction openings JNL and JN1 to JN3. The junction openings JNL and JN1 to JN4 connect the respective chambers with the interface part IF. Each of the junction openings JNL and JN1 to JN3 are formed to have a size which allows the substrate S to pass through. The substrate S can be transported between chambers through the junction openings JN1 to JN4.

The junction opening JNL connects the accommodation room RMI of the common chamber device CBI with the accommodation room RML of the anti-lock chamber device CBL. The junction opening JN1 connects the accommodation room RMI with the first chamber device CB1 of the accommodation room RM1. The junction opening JN2 connects the accommodation room RMI with the second chamber device CB2 of the accommodation room RM2. The junction opening JN3 connects the accommodation room RMI with the third chamber device CB3 of the accommodation room RM3.

The accommodation room RMI is provided with a robot device RBT which has an arm part ARM. The arm part ARM is connected to the base portion END of the robot device RBT. The base portion FND is adapted to be movable in the Z direction (upward and downward) by a driving mechanism (not shown). The arm part ARM is formed to be extendable on the XY plane in one direction. The arm part ARM is provided to be rotatable in the θZ direction centering around the connected portion on the base part FND.

Each of the accommodation room RML of the anti-lock chamber device CBL, the accommodation room RM1 of the first chamber device CB1 and the accommodation room RM2 of the second chamber device CB2 has a substrate holding part HLD which holds the substrate S. In the present embodiment, in the accommodation room RML, the accommodation room RM1 and the accommodation room RM2, the substrate S is treated while being held by the substrate holding part HLD.

The accommodation room RM1 of the first chamber device CB1 is provided with a coating part CT and a maintenance part MN. The coating part CT includes a nozzle NZ and a guide mechanism G. The nozzle NZ is adapted to be movable along the guide mechanism G. The guide mechanism G extends over a surface (e.g., a face on the +Z side) of the substrate S held by the substrate holding part HLD. Thus, the nozzle NZ is adapted to be movable by scanning the entire surface of the substrate S.

The maintenance part MN has a nozzle control part NTC which controls the tip of the nozzle NZ. The nozzle control part NTC is disposed laterally to the substrate holding part HLD. The guide mechanism G extends over the substrate holding part HLD and the nozzle control part NTC, and is capable of accessing the nozzle NZ to the nozzle control part NTC.

Each of the accommodation room RM3 of the third chamber device CB3 and the accommodation room RM4 of the fourth chamber device CB4 is provided with a substrate transporting mechanism TR which is the same as in the aforementioned embodiments. The accommodation room RM3 is provided with a plurality of transport rollers 53 in one direction, and the accommodation room RM4 is provided with a plurality of transport rollers 54 in one direction. In the third chamber device CB3 and the fourth chamber device CB4, the accommodation room RM3 and the accommodation room RM4 are adapted to transport the substrate S in one direction.

The accommodation room RM2 of the second chamber device CB2 is provided with a heating part HT2, an inert gas supply part GS and an exhaust part EXH. The second chamber device CB2 is adapted to perform drying under reduced pressure. The accommodation room RM3 of the second chamber device CB3 is provided with a heating part HT3. In the accommodation room RM3, the heating part HT3 is provided at a plurality of portions, e.g., 2 portions. In the accommodation room RM3, the heating operation can be performed to heat the substrate S at a higher temperature than the heating operation performed in the accommodation room RM2. The accommodation room RM4 of the fourth chamber device CB4 is provided with a cooling part CL. By using the cooling part CL, the cooling of the substrate S can be performed in the accommodation room RM4.

Next, the operation of the coating apparatus CTR3 having the above configuration will be described.

Firstly, the substrate S is loaded through the substrate loading opening ENT of the anti-lock chamber device CBL (substrate loading part LIAR) into the accommodation room RML, and held with the substrate holding part HLD. After holding the substrate S with the substrate holding part HLD, the control device CONT opens the gate valve GB between the anti-lock chamber device CBL and the interface part IF.

After opening the gate valve GB, the control device CONT allows the arm part ARM of the robot device RBT provided in the interface part IF to access the accommodation room RML. The control device CONT uses the arm part ARM accessed to the accommodation room RML to lift the substrate S held by the substrate holding part HLD, and transports the substrate S to the interface part IF through the junction opening JNL.

Next, the control device CONT opens the gate valve GB between the common chamber device CBI and the first chamber device CB1, and allows the arm part ARM holding the substrate S to access the accommodation room RM1 of the first chamber device CB1. The control device CONT mounts the substrate S on the substrate holding part HDL of the first chamber device CB1, and then returns the arm part ARM to the common chamber device CBI.

After returning the arm part ARM, the control device CONT closes the gate valve GB of the first chamber device CB1, and performs a coating operation inside the accommodation room RM1. The coating operation can be performed, for example, by moving the nozzle NZ and ejecting a liquid material from the nozzle NZ to the surface (e.g., +Z-side face) of the substrate S while maintaining the substrate S mounted on the substrate holding part HLD, thereby forming a coating film of the liquid material on the entire surface of the substrate S.

The nozzle NZ, for example, moves along the guide mechanism G over the surface of the substrate S, and ejects the liquid material to the surface of the substrate S. In this manner, the coating film of the liquid material can be uniformly formed on the surface of the substrate S. The control device CONT uses the nozzle control device NZ regularly or irregularly to control the tip (−Z side tip) of the nozzle Z.

After the coating operation, the control device CONT opens the gate valve GB of the first chamber device CB1, and unloads the substrate S on the substrate holding part HLD of the accommodation room RM1 to the common chamber device CBI by the arm part ARM. After unloading the substrate S, the control device CONT opens the gate valve GB between the common chamber device CBI and the second chamber device CB2, and uses the arm part ARM to load the substrate S into the accommodation room RM2 of the second chamber device CB2.

The control device CONT moves the arm part ARM so as to hold the substrate S by the substrate holding part HLD of the accommodation room RM2. After the substrate S has been held, the control device CONT returns the arm part ARM to the common chamber CBI, and closes the gate valve GB of the second chamber device CB2. After hermetically closing the accommodation room RM2, the control device CONT reduces the pressure inside the accommodation room RM2 using the exhaust part and uses the inert gas supply part GS to change the atmosphere inside the accommodation room RM2 to an inert gas atmosphere. While maintaining the inert gas atmosphere under reduced pressure inside the accommodation room RM2, the control device CONT uses the heating part HT2 to dry the coating film of the liquid material formed on the surface of the substrate S.

After the drying operation, the control device CONT operates the arm part ARM, and unloads the substrate S from the accommodation room RM2 and loads the substrate S into the accommodation room RM3 of the third chamber device CB3. After loading the substrate S into the accommodation room RM3, the control device CONT operates the transporting mechanism TR to transport the substrate S to a treating position between the two heating parts HT3. When the substrate S arrives at the treating position, the control device CONT operates the heating part HT3 to bake the substrate S. After the baking operation, the control device CONT operates the transporting mechanism to load the substrate S into the accommodation room RM4 of the fourth chamber device CB4.

After loading the substrate S into the accommodation room RM4, the control device CONT operates the cooling part CL to cool the substrate S. After the cooling operation, the control device CONT unloads the substrate S from the substrate unloading opening EXT provided on the +X side of the fourth chamber device CB4 to the outside of the coating apparatus CTR3.

Thus, as described above, according to the present aspect, the anti-lock chamber device CBL, the first chamber device CB1, the second chamber device CB2 and the third chamber device CB3 are connected to the common chamber device CBI, and the substrate S is transported to each chamber device by the robot device RBT via the interface part IF. By this configuration, an efficient treatment becomes possible.

In such a ease, by serially connecting the third chamber device CB3 in which the baking operation is performed to the fourth chamber device CB4 in which the cooling operation is performed, the baked substrate S can be unloaded from the coating apparatus CTR3 without loading into the common chamber device CBI. As a result, temperature rise inside the common chamber device CBI can be prevented.

While preferred embodiments of the present invention have been described and illustrated above, it should be understood that these are exemplary of the present invention and are not to be considered as limiting. Additions, omissions, substitutions, and other modifications can be made without departing from the spirit or scope of the present invention. Accordingly, the present invention is not to be considered as being limited by the foregoing description, and is only limited by the scope of the appended claims.

What is claimed is:

1. A coating method comprising:
coating a liquid material including an oxidizable metal on a substrate a plurality of times to laminate a plurality of liquid material layers on the substrate; and
adjusting at least one of oxygen concentration and humidity inside a chamber having a coating space in which the coating part applies the liquid material on the substrate and a transport space into which the liquid material is transported.

2. The coating method according to claim 1,
wherein coating the liquid material comprises forming a dopant layer between the plurality of liquid material layers.

3. The coating method according to claim 1,
wherein coating the liquid material comprises coating a plurality of liquid materials having different metal compositions.

4. The coating method according to claim 1,
wherein coating the liquid material further comprises drying surfaces of the plurality of liquid material layers.

5. The coating method according to claim 1,
wherein coating the liquid material is performed while moving the substrate.

6. The coating method according to claim 1,
wherein the metal comprises at least one of copper, indium, gallium, and selenium.

7. The coating method according to claim 1, further comprising:
heating the substrate after coating the liquid material to bake the plurality of the liquid material layers.

8. The coating method according to claim 7, further comprising:
cooling the substrate after heating the substrate.

9. A coating apparatus comprising:
a plurality of coating parts which apply a liquid material including an oxidizable metal on a substrate;
a chamber having a coating space in which the coating part applies the liquid material on the substrate and a transport space into which the liquid material is transported; and
an adjusting part which adjusts at least one of oxygen concentration and humidity inside the chamber.

10. The coating apparatus according to claim 9,
wherein the plurality of coating parts include a second coating part which coats dopant on the substrate.

11. The coating apparatus according to claim 9,
wherein the plurality of coating parts coat a plurality of liquid materials having different metal compositions.

12. The coating apparatus according to claim 9, further comprising:
a drying mechanism which dries a surface of the liquid material coated on the substrate.

13. The coating apparatus according to claim 9, further comprising:
a transporting mechanism which transports the substrate in a predetermined transporting direction,
wherein the plurality of coating parts are arranged along the transporting direction.

14. The coating apparatus according to claim 9,
wherein a plurality of the drying mechanisms are arranged in the transporting direction, and
wherein the plurality of coating parts and the plurality of drying mechanisms are alternately arranged in a moving direction of the substrate.

15. The coating apparatus according to claim 14,
wherein each of the drying mechanisms is disposed at a position deviated from one of the plurality of coating parts in plan view.

16. The coating apparatus according to claim 14,
wherein the chamber includes partition members which partition the inside of the chamber into a plurality of sections each including one coating part and one drying mechanism.

17. The coating apparatus according to claim 16,
wherein the chamber includes a second partition member which partitions one of the plurality of sections to separate the coating part and the drying mechanism.

18. The coating apparatus according to claim 9,
wherein the metal comprises at least one of copper, indium, gallium, and selenium.

19. The coating apparatus according to claim 9, further comprising:
a heating mechanism for baking the liquid material on the substrate.

20. The coating apparatus according to claim 19, further comprising:
a cooling mechanism for cooling the substrate which has been heated by the heating mechanism.

21. The coating apparatus according to claim 20,
wherein the chamber has a plurality of accommodation rooms capable of accommodating the substrate, and
the heating mechanism and the cooling mechanism axe accommodated in separate accommodation rooms.

22. The coating apparatus according to claim 21,
wherein the coating part is provided with a nozzle which is accommodated in an accommodation room other than the accommodation rooms having the heating mechanism and the cooling mechanism accommodated.
